(19) United States
(12) Patent Application Publication
(10) Pub. No.: US 2014/0218743 A1
(43) Pub. Date: Aug. 7, 2014

(54) Wavelength-Tunable Light Source Apparatus, Driving Method Thereof, Optical Tomographic Image Acquisition Apparatus Including Wavelength-Tunable Light Source Apparatus, and Optical Tomographic Image Acquisition Method

(71) Applicant: CANON KABUSHIKI KAISHA, Tokyo (JP)

(72) Inventors: Takeshi UCHIDA, Tokyo (JP); Eiichi FUJII, Kamakura-shi (JP)

(73) Assignee: CANON KABUSHIKI KAISHA, Tokyo (JP)

(21) Appl. No.: 14/167,912

(22) Filed: Jan. 29, 2014

(30) Foreign Application Priority Data
Feb. 1, 2013 (JP) 2013-018630

(51) Int. Cl. G01B 9/02; G02B 6/42; G02B 6/43

(52) U.S. Cl. CPC G01B 9/02091; G02B 6/43; G02B 6/4296
USPC 356/479; 385/24

(57) ABSTRACT

A wavelength-tunable light source apparatus that has a wavelength-tunable light source that simultaneously operates a plurality of light sources with different wavelengths to emit light, includes:
a plurality of variable-wavelength light generation units forming the wavelength-tunable light source;
a multiplexing unit configured to multiplex light of a plurality of wavelengths generated by the variable-wavelength light generation unit so as to be adjusted to one waveguide; and
a control unit configured to control the plurality of the variable-wavelength light generation units to emit the light with different wavelength simultaneously in at least part of time, and control optical intensity such that wavelength dependence of the optical intensity generated from the plurality of variable-wavelength light generation units becomes unimodal.

### BACKGROUND OF THE INVENTION

1. Field of the Invention

The present invention relates to a wavelength-tunable light source apparatus, a driving method thereof, an optical tomographic image acquisition apparatus including the wavelength-tunable light source apparatus, and an optical tomographic image acquisition method.

2. Description of the Related Art

As an optical tomographic image acquisition apparatus that acquires a tomographic image of a living body or the like without destruction and invasion, there is known an optical tomographic image acquisition apparatus called “OCT (Optical Coherent Tomography)”.

In the OCT, a tomographic image is acquired using light. To be more specific, a tomographic image is acquired by causing light reflected from a measurement object and light from a reference mirror to interfere and performing Fourier transform of data of wavelength dependence (to be more accurate, dependence on wave number) of the interfering optical intensity. Among various optical tomographic image acquisition apparatus, there is swept source optical coherence tomography (SS-OCT) apparatus using a wavelength-tunable light source apparatus that has a wavelength-tunable light source.

This SS-OCT apparatus adopts a method of acquiring the wavelength dependence of the optical intensity after the interference by recording the change in the optical intensity on the light receiving side due to the wavelength sweep of the light source.

By the way, in an OCT or the like that intends to acquire a tomographic image of a living body, it is preferable that the acquisition speed of the tomographic image is fast.

This is because there are advantages that it is possible to acquire more images in the same time and suppress the influence due to the movement of a measuring target to the minimum.

For example, an increase of the tomographic image acquisition speed in the above-mentioned SS-OCT can be realized by speeding up the wavelength-sweep speed of the light source or acquiring data at the same time by a plurality of light sources with different wavelengths like Japanese Patent Application No. 4677636 (hereafter abbreviated as “Patent Literature 1”) and intending the shortening of the acquisition time of interference waveforms.

By the way, in the OCT, there are many cases where the optical intensity of the light emitted to an object is limited. For example, it is not only applied to the OCT in the living body, there are safety standards for the intensity of the light emitted to it, and the optical intensity of the light emitted into an eyeball is especially limited.

Therefore, in the case of operating a plurality of light sources with different wavelengths to emit light as shown in Patent Literature 1 at the same time, it is necessary to decrease the optical intensity of each light source in proportion to the number of light sources.

Further, since noise of a certain level is provided in a reception unit or a subsequent electric circuit, in the case of operating such the plurality of light sources to emit light at the same time, the signal intensity decreases due to a decrease in the optical intensity of the light sources and the SN ratio decreases as a result. Therefore, although it is possible to speed up the tomographic image acquisition speed, the SN ratio deteriorates. That is, there is a problem that the speed-up and the maintenance of the SN ratio are not compatible.

### SUMMARY OF THE INVENTION

Taking into account the above-mentioned problem, when forming an optical tomographic image acquisition apparatus including a wavelength-tunable light source apparatus so as to operate a plurality of light sources with different wavelengths to emit light at the same time, it is an object of the present invention to provide the wavelength-tunable light source apparatus, a driving method thereof, the optical tomographic image acquisition apparatus including the wavelength-tunable light source apparatus and an optical tomographic image acquisition method that can achieve the speed-up of the acquisition speed of an optical tomographic image and suppress a decrease in the SN ratio.

A wavelength-tunable light source apparatus of the present invention that has a wavelength-tunable light source that simultaneously operates a plurality of light sources with different wavelengths to emit light, includes:

a plurality of variable-wavelength light generation units forming the wavelength-tunable light source;

a multiplexing unit configured to multiplex light of a plurality of wavelengths generated by the variable-wavelength light generation unit so as to be adjusted to one waveguide; and

a control unit configured to control the plurality of the variable-wavelength light generation units to emit the light with different wavelength simultaneously in at least part of time, and control optical intensity such that wavelength dependence of the optical intensity generated from the plurality of variable-wavelength light generation units becomes unimodal.

Moreover, a driving method of a wavelength-tunable light source apparatus of the present invention of driving the wavelength-tunable light source apparatus including a wavelength-tunable light source that simultaneously operates a plurality of light sources with different wavelengths to emit light, includes:

a plurality of variable-wavelength light generation units forming the wavelength-tunable light source; and

a multiplexing unit configured to multiplex light of a plurality of wavelengths generated by the variable-wavelength light generation unit so as to be adjusted to one waveguide,

in which the light of the plurality of wavelengths generated by the variable-wavelength light generation unit is simultaneously generated in at least part of time and optical intensity is controlled such that wavelength dependence of the optical intensity generated from the plurality of variable-wavelength light generation units becomes unimodal.

Moreover, an optical tomographic image acquisition apparatus of the present invention includes: the above-mentioned wavelength-tunable light source apparatus;

an optical system configured to divide light from the wavelength-tunable light source apparatus into measurement light and reference light, lead the measurement light to a measurement object and acquire reflected light from the measurement object, a reference optical system configured to transmit light divided as the reference light for a certain distance and an interference optical system configured to interfere with the reflected light from the measurement object and the reference light transmitted for the certain distance;

a light receiving unit configured to receive the interference light from the interference optical system; and

an image processing unit configured to acquire a tomographic image of the measurement object based on the light received by the light receiving unit.

Moreover, an optical tomographic image acquisition method of the present invention includes: using the above-mentioned wavelength-tunable light source apparatus;

a reference optical system configured to divide light from the wavelength-tunable light source apparatus into measurement light and reference light, lead the measurement light to a measurement object and transmit the reference light for a certain distance; generating interference light by returned light reflected by the measurement object and the reference light transmitted for the certain distance, and receiving the light in a light receiving unit; and

acquiring a tomographic image of the measurement object based on the light received by the light receiving unit.

Further features of the present invention will become apparent from the following description of exemplary embodiments (with reference to the attached drawings).

### BRIEF DESCRIPTION OF THE DRAWINGS

FIG. 1 is a view to describe a configuration example of an optical tomographic image acquisition apparatus including a wavelength-tunable light source apparatus, and an optical tomographic image acquisition method in Example 1 of the present invention;

FIGS. 2A-B are views to describe a configuration example of an optical tomographic image acquisition apparatus and optical tomographic image acquisition method that control the optical intensity such that the wavelength dependence of the optical intensity generated from each of a plurality of variable-wavelength light generation units is unimodal in Example 1 of the present invention;

FIG. 3 is a view to describe a configuration example of an optical tomographic image acquisition apparatus including a wavelength-tunable light source apparatus, and an optical tomographic image acquisition method in Example 2 of the present invention;

FIGS. 4A-B are views to describe a configuration example of an optical tomographic image acquisition apparatus and optical tomographic image acquisition method that control the optical intensity such that the wavelength dependence of the optical intensity generated from each of a plurality of variable-wavelength light generation units is unimodal in Example 2 of the present invention;

FIGS. 5A-C are views to describe a calculation result based on signal waveforms acquired in three kinds of assumed driving conditions in an embodiment of the present invention;

FIGS. 6A-B are views to describe a data example after Fourier transform in an embodiment of the present invention; and

FIGS. 7A-C are views to describe the comparison of noise levels after performing Fourier transform of each signal in FIG. 5 in an embodiment of the present invention.

### DESCRIPTION OF THE EMBODIMENTS

Next, configuration examples of a wavelength-tunable light source apparatus, a driving method thereof, an optical tomographic image acquisition apparatus including the wavelength-tunable light source apparatus, and an optical tomographic image acquisition method are described.

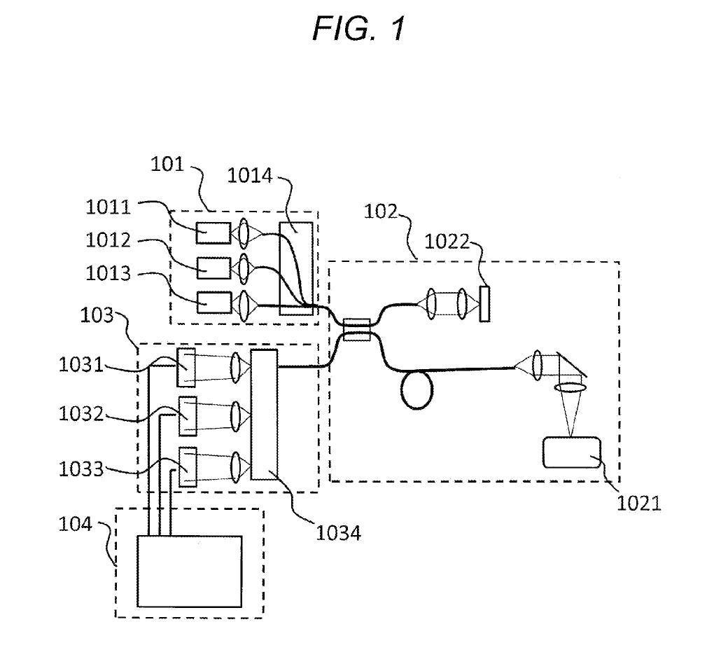

As illustrated in FIG. 1, a wavelength-tunable light source apparatus (101) of the present embodiment includes

a plurality of variable-wavelength light generation units (a first variable-wavelength light generation unit 1011, a second variable-wavelength light generation unit 1012 and a third variable-wavelength light generation unit 1013) and a multiplexing unit (1014) that multiplexes the light of the plurality of wavelengths to adjust to one waveguide.

Moreover, it includes a control unit (not illustrated) that controls the optical intensity such that the plurality of variable-wavelength light generation units is simultaneously activated in at least part of the time and the wavelength dependence of the optical intensity generated from the plurality of variable-wavelength light generation units is unimodal.

In such a configuration, a plurality of wavelength-tunable light sources is simultaneously lighted in at least part of the time in an acquisition period of interference waveforms. Further, in a case where the optical intensity emitted from each light source is arranged on the wavelength axis, the optical intensity emitted from a wavelength-sweeping light source is changed such that the wavelength (wave number) dependence of the optical intensity has a unimodal shape, to be more preferable, the wavelength dependence of a Gaussian function shape.

To be more specific, with the first intensity of the largest intensity, the third intensity of the smallest intensity and the medium second intensity between the first intensity and the third intensity in the intensity of light generated in the plurality of variable-wavelength light generation units,

The light of the plurality of wavelengths is generated at the same time in at least part of a wavelength region between the second intensity and the third intensity.

By doing this, it is possible to shorten the sweep time and reduce the deterioration of the SN ratio.

The reason why the sweep time is shortened and the deterioration of the SN ratio is suppressed by making the optical intensity of the light sources unimodal in this way is described below.

In the following, a qualitative explanation is given first and the effect is specifically described with a calculation example afterwards.

First, the qualitative explanation is given.

Here, the intensity of light emitted from a light source in the SS-OCT is considered. In the case of a driving method that operates only one normal light source, a method of maintaining the light output to a certain value closer to a limit value is adopted.

In this case, the wavelength dependence of the optical intensity becomes constant, and, when it is indicated by a graph in which the horizontal axis represents the wavelength and the vertical axis represents the optical intensity, it becomes a straight line with a certain value parallel to the x axis.

Here, although a plurality of light sources is provided, the same applies to a case where only one light source emits light.

Further, after acquiring an interference waveform (wavelength dependence of the interfering optical intensity), an OCT system finds a tomographic image using Fourier transform.

Here, the present inventors noted the following point in this Fourier transform.

That is, they noted that, in the Fourier transform, by its nature, the variation of data subjected to the Fourier transform due to noise on the vicinity of the center of the x range (in this case, a wavelength range, more accurately, a wave number) is larger than the variation of the data subjected to the Fourier transform due to noise on the edge of the wavelength range.

In a case where the optical intensity of a light source in a light source apparatus is weakened, since the noise intensity caused in an electric circuit is constant, the SN ratio of an interference signal is decided by the optical intensity of the light source regardless of the wavelength.

However, in the case of performing the Fourier transform on it, since a window function is multiplied, the state varies after the Fourier transform.

To be more specific, the used window function is large in the vicinity of the center of the wavelength band and small in the edge. Therefore, it is compressed in the edge as compared with the data in the vicinity of the center.

Therefore, even if the signal SN ratio is constant, the absolute value of the level of the noise compressed by the window function is large in the vicinity of the center and small in the periphery.

Further, even if the absolute value of the noise in the periphery becomes small, when it is equal to or less than a certain level, the influence on a tomographic image after the Fourier transform is predominant in the noise with strong intensity in the vicinity of the center, and there is weak influence on the noise level in the periphery.

In other words, the influence on the tomographic image due to the deterioration of the SN ratio in the case of reducing the optical intensity in the periphery is smaller than a case where the optical intensity in the central part of the sweep bandwidth is reduced.

In summary, the influence on a tomographic image due to the deterioration of the SN ratio by reducing the optical intensity of a light source depends on the wave number, more accurately, the position from the center of the sweep band, and the influence is smaller in the wave number domain in the edge of a sweep range than in the vicinity of the center.

Therefore, in the present invention, light is emitted with an almost limit value where the output of the light source can be emitted, in the vicinity of the center of the wavenumber range in which there is a large influence on the tomographic image.

Meanwhile, in the edge of the wavelength range, light is emitted with a lower light amount to make the wavelength dependence of the light amount unimodal, for example, a Gaussian function shape with respect to the wavenumber. By this means, it is possible to suppress the deterioration of the SN ratio due to the light amount decrease to the minimum.

Further, in a part of the wavelength edge in which there is leeway in the limit value of the light output, light from another light source with a different wavelength is emitted at the same time and an interference signal of the position of the different wavelength is acquired at the same time.

By this means, since the deterioration of the SN ratio is suppressed and interference waveforms of different wavelengths are acquired at the same time, it is possible to shorten the time required to acquire the interference waveform of the entire necessary wavelength range.

Regarding the relationship between the shape of the optical intensity and the SN ratio qualitatively described above, calculation examples are shown below. In this calculation, calculation results are compared on three conditions.

The first condition is a case where wavelength sweep is performed by a constant value of optical intensity of 1.0 (intensity of 1.0 is assumed to be an optical intensity limit value).

The second condition is a case where simultaneous sweep by two light sources is assumed and the sweep by a constant value of emission intensity of 0.5 is performed.

Further, the third condition is a case where the intensity is changed into the Gaussian function shape that is a feature of the present invention.

In this case, as specifically shown in the example, since it is possible to set the maximum value of the emission intensity to a light output limit value even in the case of performing simultaneous sweep, the maximum value is 1.0.

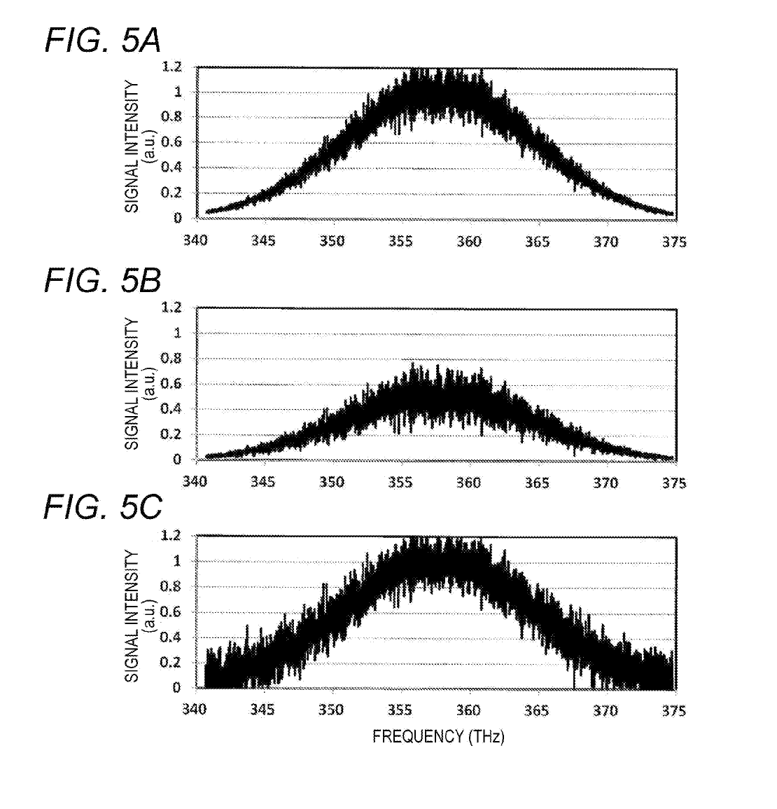

FIG. 5 shows the shapes of signals in which wavelength sweep is performed on respective conditions and window functions required for acquired signals are multiplied afterwards.

These are states immediately before Fourier transform. FIG. 5A illustrates a graph in a case where wavelength sweep is performed by a constant value of optical intensity of 1.0 (intensity of 1.0 is assumed to be an optical intensity limit value), FIG. 5B shows a graph in a case where simultaneous sweep by two light sources is assumed and the sweep is performed by a constant value of the emission intensity of 0.5, and FIG. 5C is a graph in a case where the intensity is changed into the Gaussian function shape that is a feature of the present invention.

Here, as for the level of noise in the calculation, larger noise than usual is provided so as to understand the difference on the graphs on respective conditions.

From FIGS. 5A and 5B, even in a case where noise of constant intensity is provided over the whole of the sweep range, it is understood that the absolute value of the noise on the edge of the band is small due to the influence of the multiply of the window functions.

Meanwhile, in the case of the present invention of FIG. 5C, since Gaussian-shaped optical intensity is originally provided and the Fourier transform is performed without multiplying the window function, the intensity of the noise on the edge of the band is not compressed and is provided while the level is maintained.

When FIGS. 5B and 5C are compared, although the noise intensity in the vicinity of the center of the sweep band is identical, since the signal decreases to 0.5 in FIG. 5B, the SN ratio is large.

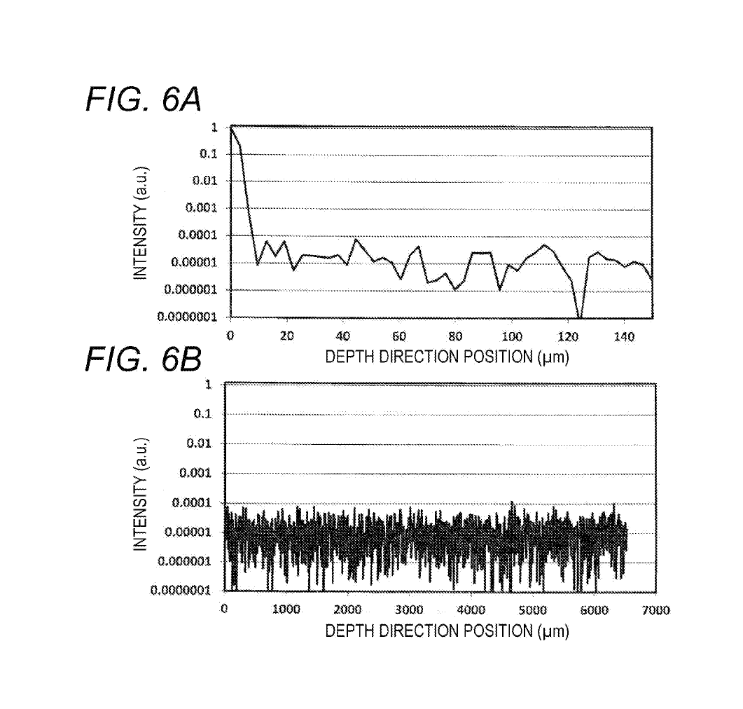

FIG. 6 illustrates examples of waveforms after Fourier transform.

FIG. 6A illustrates a region in which the value of x is relatively small, and FIG. 6B illustrates the whole of it. In FIG. 6A, the value in x=0 is set to 1 and rapidly decreases therefrom according to an increase in x. In this figure, the horizontal axis corresponds to the depth direction position of a tomographic image and the half value of this decreasing part corresponds to the resolution of an OCT tomographic image.

Further, when x becomes larger than this rapid decreasing region, it becomes a region in which noise of a certain level exists.

It is understood from FIG. 6B that noise is expanded over the entire tomographic image. In this calculation, the ways of variation of the noise level of this noise region on three conditions described above are compared.

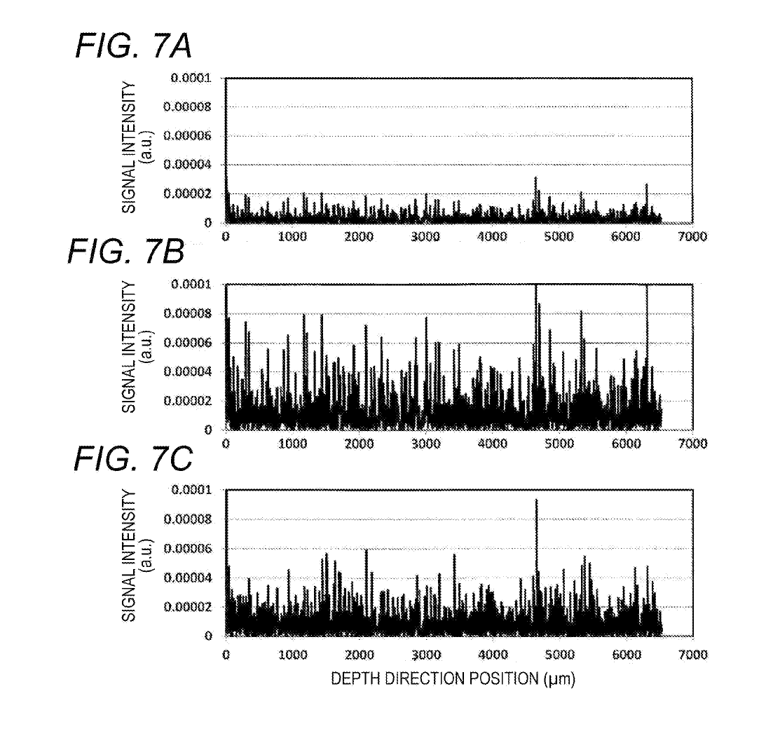

FIG. 7 illustrates a view where the noise levels on respective conditions are compared.

FIG. 7A illustrates a case where wavelength sweep is performed by a constant value of optical intensity of 1.0 (intensity of 1.0 is assumed to be an optical intensity limit value), FIG. 7B illustrates a case where simultaneous sweep by two light sources is assumed and the sweep is performed by a constant value of emission intensity of 0.5, and FIG. 7C illustrates a case where the intensity is changed into the Gaussian function shape that is a feature of the present invention. In FIG. 7B, it is understood from this that the noise level increases as compared with FIG. 7A.

It is understood from this that, when the optical intensity becomes half, the SN ratio deteriorates even if the sweep waveform is identical. Meanwhile, in FIG. 7C in which the sweep is performed by the optical intensity of the Gaussian function shape, the noise level is higher as compared with FIG. 7A. That is, as compared with a case where the whole is swept by a constant value of optical intensity of 1.0, the SN ratio deteriorates.

However, since up to the limit value of the optical intensity is used over the entire region in FIG. 7A, there is no room to sweep a plurality of light sources at the same time, and the speeding-up by means of it is impossible.

When FIGS. 7(b) and 7(c) are compared where different wavelengths of a plurality of light sources can be swept at the same time, it is understood that the noise level is lower in FIG. 7C where the sweep is performed by the sweep waveform of the Gaussian function shape of the present invention than FIG. 7(b) where the whole is swept by a constant value of 0.5.

That is, in a case where a plurality of light sources is swept at the same time, it is understood that it is possible to suppress the decrease in the SN ratio by the sweep method of the present invention.

As described above, according to the configuration of the present embodiment, it is possible to realize an optical tomographic image acquisition apparatus and an optical tomographic image acquisition method that can suppress the decrease in the SN ratio.

Also, the number of light sources and the timing of light emission are specifically shown in the following examples.

### EXAMPLE

Specific configuration examples such as the number of light sources and the timing of light emission in the optical tomographic image acquisition apparatus and optical tomographic image acquisition method of the examples of the present invention are described below.

### Example 1

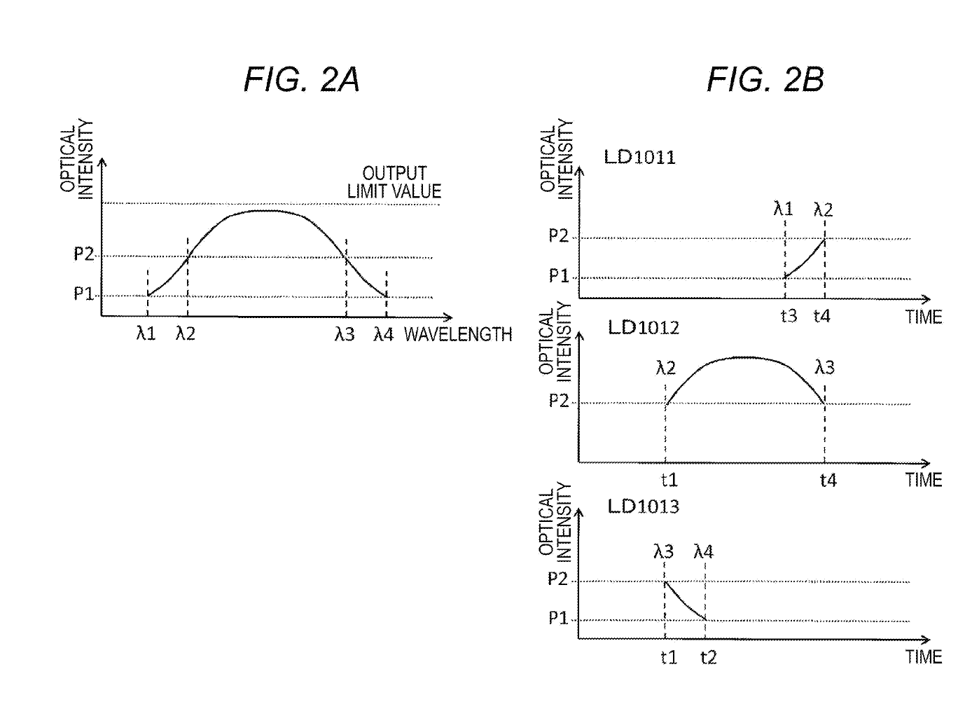

As Example 1, configuration examples of an optical tomographic image acquisition apparatus including a wavelength-tunable light source apparatus of the present invention and an optical tomographic image acquisition method are described using FIGS. 1 and 2.

FIG. 1 illustrates the structure of the optical tomographic image acquisition apparatus (OCT system) in this Example 1.

The OCT system of this example divides light from the wavelength-tunable light source apparatus 101 into the measurement light and the reference light, leads the measurement light to a measurement object 1021 and leads the reference light to a reference mirror 1022.

Further, it is configured such that, through an optical system that generates interference light by return light reflected by the measurement object and the reference light reflected by the reference mirror, this interference light is received in a light receiving unit 103 and a tomographic image of the measurement object is acquired on the basis of this received light.

To be more specific, it is configured with a laser diode (hereinafter referred to as “LD”) 1011, LD 1012, and LD 1013 that are three independent wavelength-tunable light generation units, and the multiplexing unit 1014 that multiplexes light emitted from those three LDs.

Further, those items of light are emitted to the measurement object 1021 and the reference reflection mirror (reference mirror) 1022 in an OCT optical system 102 and reflected light therefrom is caused to interfere. Further, the interference light is entered into the light receiving unit 103.

In the light receiving unit 103, first, it is demultiplexed into the sweep wavelength band of each LD, that is, the light of each LD in a wavelength filter 1034.

Afterwards, each light is acquired by a PD 1031, PD 1032, and PD 1033 that are interference signal light receiving units forming the light receiving unit, as respective interference signals.

Further, the waveform of the light received by each PD is sent to a signal processing unit (image processing unit) 104 and added with respect to the wavelength axis to generate the interference waveform of the entire sweep range. Afterwards, the interference waveform is transformed into a tomographic image by the Fourier transform.

FIG. 2A illustrates the intensity change of light sources with respect to a finally acquired wavelength (a graph in which the intensity change for three light sources is arranged with respect to the wavelength axis).

Thus, although wavelength sweep is performed by three LDs forming the wavelength-tunable light source apparatus, in a case where the optical intensity of three LDs is finally arranged in one graph, the optical intensity of each LD is changed by a control unit (not illustrated) that controls the optical intensity, such that the wavelength dependence of the optical intensity generated from three LDs becomes unimodal.

Here, the wavelength-tunable range of the LDs forming the wavelength-tunable light source apparatus in FIG. 1 is between λ1 and λ2 in the LD 1011, between λ2 and λ3 in the LD 1012, and between λ3 and λ4 in the LD 1013.

FIG. 2B illustrates the timings on the time axis of the emission intensity of three wavelength-tunable LDs forming the wavelength-tunable light source apparatus 101, and wavelengths at the start points and the end points.

In the present example, first, the LD 1012 starts emitting light at time t1 and emits the light with the illustrated intensity change up to t4. The wavelength is swept from λ2 to λ3 at this time.

At the same time with the LD 1012, the LD 1013 also starts the sweep at time t1. The LD 1013 emits light from time t1 to time t2. The emission intensity gradually decreases. Moreover, the wavelength is swept from λ3 to λ4. Therefore, the LD 1012 and the LD 1011 emit light at the same time and sweep respective wavelength domains between t1 and t2.

Meanwhile, the LD 1011 does not emit light at first as illustrated in FIG. 2B, and starts emitting light at the timing of t3. Further, it emits the light up to t4. At this time, the LD 1012 and the LD 1011 emit light at the same time. The sweep wavelength of the LD 1011 starts from λ1, the sweep is performed up to λ2 and the intensity gradually increases.

By performing the sweep in this way, when signals swept in three wavelength-tunable LDs are finally arranged on the wavelength axis, it is possible to acquire signals equivalent to signals of the result of performing the sweep with the unimodal intensity change as illustrated in FIG. 2A.

Further, by sharing the sweep by respective LDs and performing the sweep in part of the time domain at the same time, it is possible to make the wavelength sweep speed (wavelength change speed) with respect to the wavelength of each LD identical and shorten the time to acquire the signals.

Moreover, another LD performs sweep while avoiding the time at which the LD 1012 sweeps the wavelength in the vicinity of the center, such that the optical intensity does not exceed the total value adding the ones of the LDs, and therefore it is possible to perform the sweep without exceeding the limit value.

As a result, it is possible to suppress the decrease in the SN ratio and acquire a tomographic image at higher speed.

Here, as the temporal timing of wavelength sweep in the present example, instead of the LD 1011, the LD 1013 is simultaneously swept together with the LD 1012 at the timing of time t1

This is because it is preferable to prevent light of similar wavelengths from emitted from different LDs at the same timing.

For example, since the optical intensity does not exceed the limit value in a case where the wavelength sweep is started in the LD 1011 and the LD 1012 at the timing of time t1, both of them start the sweep from λ2, the sweep direction of the LD 1012 is directed to λ3 on the long wavelength side and the LD 1011 performs the sweep in the direction of λ1 on the short wavelength side.

Then, two LDs emit light with the same wavelength of λ2 at time t1, and it becomes difficult for the light receiving unit 103 to perform demultiplexing for each LD and acquire interference signals.

However, in a case where different light sources emit light with similar wavelengths in this way, if the light receiving unit can perform demultiplexing, the effect of the present invention is achieved as well as the present example.

Therefore, for example, in a case where LDs with different polarization directions are used and the light receiving unit 103 performs demultiplexing using the difference of the polarization directions, a driving method is possible in which different light sources emit light with similar wavelengths at the same timing.

### Example 2

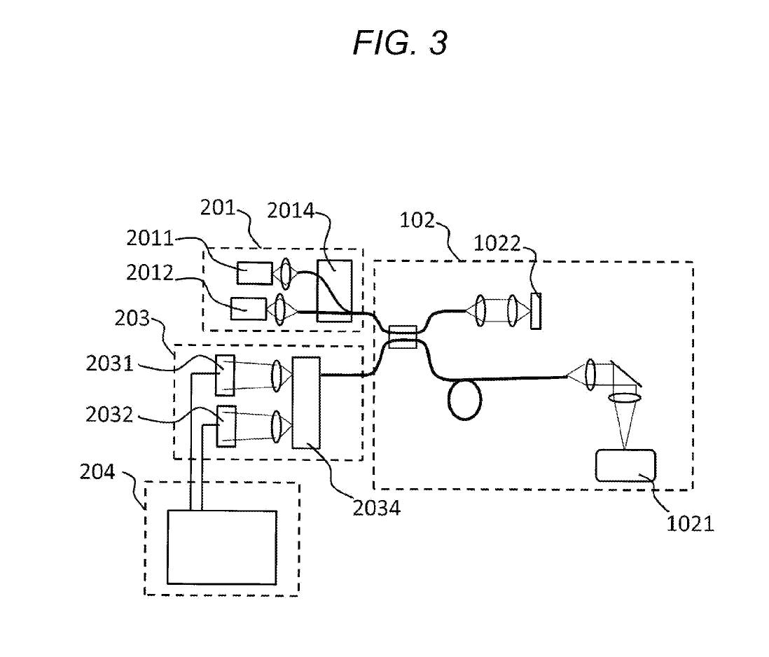

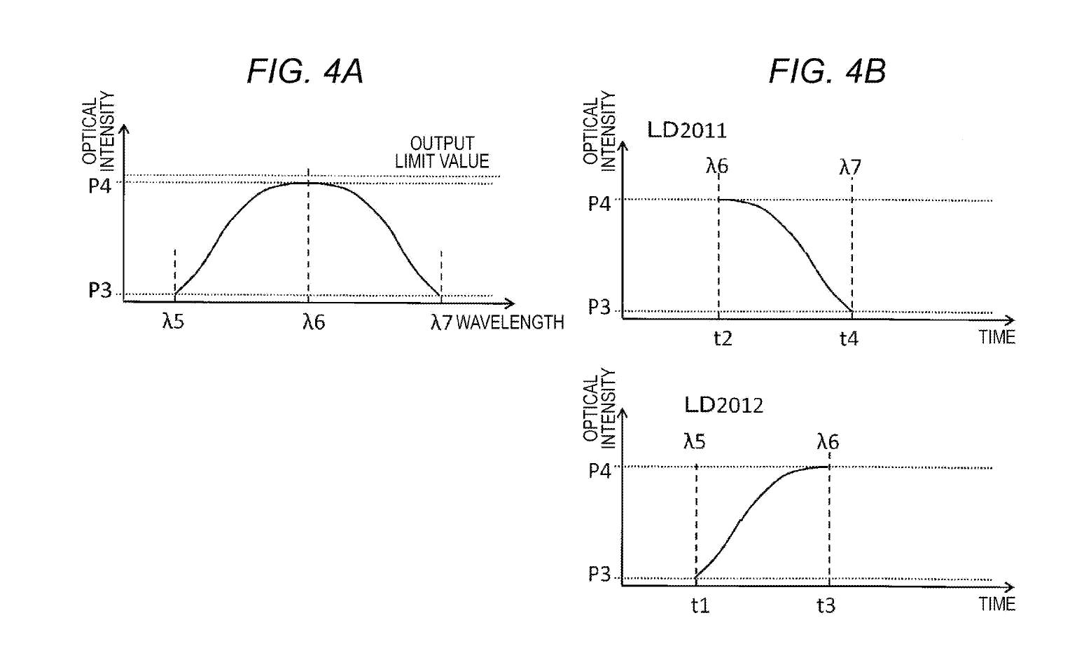

As Example 2, the configuration examples of an optical tomographic image acquisition apparatus including a wavelength-tunable light source apparatus and an optical tomographic image acquisition method according to a mode different from Example 1 are described using FIGS. 3 and 4.

FIG. 3 illustrates an optical tomographic image acquisition apparatus (OCT system) of the present example.

Although three wavelength-tunable light sources are used in Example 1, two wavelength-tunable LDs are used in the present example.

The OCT system of the present example includes a wavelength-tunable light source apparatus 201, the OCT optical system 102, a light receiving unit 203 and a signal processing unit 204.

The wavelength-tunable light source apparatus 201 includes two LDs 2011 (fourth variable-wavelength light generation unit) and 2012 (fifth variable-wavelength light generation unit) of the fourth variable-wavelength light generation unit and the fifth variable-wavelength light generation unit, and a multiplexing unit 2014.

Since the same materials as Example 1 are used in the OCT optical system 102, the same numbers are assigned.

The light receiving unit 203 includes a wavelength filter 2034 and two PDs 2031 and 2032 that receive demultiplexed light.

FIG. 4A illustrates the intensity change of light sources with respect to a finally acquired wavelength (a graph in which the intensity change for two light sources is arranged with respect to the wavelength axis). Although wavelength sweep is performed by two LDs forming the light source unit, in a case where the optical intensity of two LDs is finally arranged in one graph, the optical intensity of each LD is changed so as to become unimodal.

FIG. 4B illustrates the timings on the time axis of the emission intensity of two wavelength-tunable LDs forming the wavelength-tunable light source apparatus 201, and wavelengths at the start points and the end points.

In the present example, first, the LD 2011 starts emitting light at time t1 and emits the light with the illustrated intensity change up to t3. The wavelength is swept from λ5 to λ6 at this time.

The LD 2012 starts sweep at time t2 slightly later than the LD 2011. The LD 2012 emits light from time t2 to time t4.

The emission intensity gradually decreases. Moreover, the wavelength is swept from λ6 to λ7. Therefore, the LD 2011 and the LD 2012 emit light at the same time and sweep respective wavelength domains between t1 and t3.

As shown in two above-mentioned examples, in the present invention, the optical intensity of light sources is made unimodal, more preferably formed in the Gaussian function shape in an acquired wavelength domain, when another light source is configured to emit light at the timing at which there is a large difference from the light output limit value, and different wavelength domains are swept at the same time. By this means, it is intended to shorten the tomographic image acquisition time.

Therefore, in the present invention, the number of light sources held by the OCT system is not limited to two or three in the examples.

It may be four or more if the light output is changed to be unimodal with respect to the wavelength (more accurately, wave number) axis of acquired data and a plurality of light sources is driven in a range that does not exceed the optical output limit value.

Moreover, the light source may be a wavelength-tunable light source including a semiconductor light amplification unit and an optical system of a wavelength mechanism outside thereof, besides a wavelength-tunable LD (wavelength-tunable laser diode) in the examples.

Moreover, regarding an optical tomographic image acquisition apparatus that uses light emitted from light sources, an effect is provided if it is configured with a unit that divides the light of the light sources and emits one to a measurement object to generate its reflected light, and a unit that transmits the other for a certain distance, where a tomographic image is acquired from the interference of the reflected light and the light transmitted for the certain distance which are generated by the two units. A mirror is used as a reference optical system in the examples, it is not necessarily limited to a configuration using a mirror.

According to the present invention, when forming an optical tomographic image acquisition apparatus including a wavelength-tunable light source apparatus so as to operate a plurality of light sources with different wavelengths to emit light at the same time,

It is possible to realize the wavelength-tunable light source apparatus, a driving method thereof, the optical tomographic image acquisition apparatus including the wavelength-tunable light source apparatus and an optical tomographic image acquisition method that can achieve the speed-up of the acquisition speed of an optical tomographic image and suppress a decrease in the SN ratio.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-018630, filed Feb. 1, 2013, which is hereby incorporated by reference herein in its <or their, if more than one> entirety.

What is claimed is:

1. A wavelength-tunable light source apparatus that has a wavelength-tunable light source that simultaneously operates a plurality of light sources with different wavelengths to emit light, the wavelength-tunable light source apparatus comprising:
a plurality of variable-wavelength light generation units forming the wavelength-tunable light source;
a multiplexing unit configured to multiplex light of a plurality of wavelengths generated by the variable-wavelength light generation unit so as to be adjusted to one waveguide; and
a control unit configured to control the plurality of the variable-wavelength light generation units to emit the light with different wavelength simultaneously in at least part of time, and control optical intensity such that wavelength dependence of the optical intensity generated from the plurality of variable-wavelength light generation units becomes unimodal.

2. The wavelength-tunable light source apparatus according to claim 1, wherein, in first intensity of largest intensity, smallest third intensity and medium second intensity between the first intensity and the third intensity among intensity of the light generated by the plurality of variable-wavelength light generation units, the light of the plurality of wavelengths is simultaneously generated in at least part of a wavelength domain between the second intensity and the third intensity.

3. The wavelength-tunable light source apparatus according to claim 1,
Wherein the variable-wavelength light generation units include three variable-wavelength light generation units of a first variable-wavelength light generation unit, a second variable-wavelength light generation unit and a third variable-wavelength light generation unit,
the first variable-wavelength light generation unit generates light of a wavelength domain of a shortest wavelength,
the third variable-wavelength light generation unit generates light of a wavelength domain of a longest wavelength, and
the second variable-wavelength light generation unit generates light of a medium wavelength domain between a wavelength domain of the first variable-wavelength light generation unit and a wavelength domain of the third variable-wavelength light generation unit.

4. The wavelength-tunable light source apparatus according to claim 3, wherein a sweep direction of the wavelengths of the first to third variable-wavelength light generation units is from a short wavelength side to a long wavelength side or from the long wavelength side to the short wavelength side.

5. The wavelength-tunable light source apparatus according to claim 1,
Wherein the variable-wavelength light generation units include two variable-wavelength light generation units of a fourth variable-wavelength light generation unit and a fifth variable-wavelength light generation unit, and
a sweep direction of wavelengths of the fourth and fifth variable-wavelength light generation units is from a short wavelength side to a long wavelength side or from the long wavelength side to the short wavelength side.

6. The wavelength-tunable light source apparatus according to claim 1, wherein the variable-wavelength light generation units include a wavelength-tunable laser diode.

7. The wavelength-tunable light source apparatus according to claim 1, wherein the variable-wavelength light generation units comprise a wavelength-tunable light source including a semiconductor light amplification unit and an optical system of a wavelength mechanism outside thereof.

8. A driving method of a wavelength-tunable light source apparatus of driving the wavelength-tunable light source apparatus including a wavelength-tunable light source that simultaneously operates a plurality of light sources with different wavelengths to emit light, the driving method comprising:
a plurality of variable-wavelength light generation units forming the wavelength-tunable light source; and
a multiplexing unit configured to multiplex light of a plurality of wavelengths generated by the variable-wavelength light generation unit so as to be adjusted to one waveguide,
wherein the light of the plurality of wavelengths generated by the variable-wavelength light generation unit is simultaneously generated in at least part of time and optical intensity is controlled such that wavelength dependence of the optical intensity generated from the plurality of variable-wavelength light generation units becomes unimodal.

9. The driving method of the wavelength-tunable light source apparatus according to claim 8, wherein, in first intensity of largest intensity, smallest third intensity and medium second intensity between the first intensity and the third intensity among intensity of the light generated by the plurality of variable-wavelength light generation units,
the light of the plurality of wavelengths is simultaneously generated in at least part of a wavelength domain between the second intensity and the third intensity.

10. The driving method of the wavelength-tunable light source apparatus according to claim 8,
Wherein the variable-wavelength light generation units include three variable-wavelength light generation units of a first variable-wavelength light generation unit, a second variable-wavelength light generation unit and a third variable-wavelength light generation unit,
the first variable-wavelength light generation unit generates light of a wavelength domain of a shortest wavelength,
the third variable-wavelength light generation unit generates light of a wavelength domain of a longest wavelength, and
the second variable-wavelength light generation unit generates light of a medium wavelength domain between the first variable-wavelength light generation unit and the third variable-wavelength light generation unit.

11. The driving method of the wavelength-tunable light source apparatus according to claim 10, wherein the driving is performed with an assumption that a sweep direction of the wavelengths of the first to third variable-wavelength light generation units is from a short wavelength side to a long wavelength side or from the long wavelength side to the short wavelength side.

12. The driving method of the wavelength-tunable light source apparatus according to claim 8,
Wherein the variable-wavelength light generation units include two variable-wavelength light generation units of a fourth variable-wavelength light generation unit and a fifth variable-wavelength light generation unit, and
the driving is performed with an assumption that a sweep direction of wavelengths of the fourth and fifth variable-wavelength light generation units is from a short wavelength side to a long wavelength side or from the long wavelength side to the short wavelength side.

13. The driving method of the wavelength-tunable light source apparatus according to claim 8, wherein the variable-wavelength light generation units include a wavelength-tunable laser diode.

14. The driving method of the wavelength-tunable light source apparatus according to claim 8, wherein the variable-wavelength light generation units comprise a wavelength-tunable light source including a semiconductor light amplification unit and an optical system of a wavelength mechanism outside thereof.

15. An optical tomographic image acquisition apparatus comprising:
a wavelength-tunable light source apparatus according to claim 1;
an optical system configured to divide light from the wavelength-tunable light source apparatus into measurement light and reference light, lead the measurement light to a measurement object, transmit the reference light for a certain distance and generate interference light by returned light reflected by the measurement object and the reference light transmitted for the certain distance;
a light receiving unit configured to receive the interference light from the optical system; and
an image processing unit configured to acquire a tomographic image of the measurement object based on the light received by the light receiving unit.

16. An optical tomographic image acquisition method comprising:
using a wavelength-tunable light source apparatus according to claim 1;
dividing light from the wavelength-tunable light source apparatus into measurement light and reference light, leading the measurement light to a measurement object, transmitting the reference light for a certain distance, generating interference light by returned light reflected by the measurement object and the reference light transmitted for the certain distance, and receiving the light in a light receiving unit; and
acquiring a tomographic image of the measurement object based on the light received by the light receiving unit.
